(19) United States
(12) Patent Application Publication
(10) Pub. No.: US 2024/0418206 A1
(43) Pub. Date: Dec. 19, 2024

(54) Decompression Lock

(71) Applicant: Schwarz GmbH, Althengstett (DE)

(72) Inventor: Bernhard HOMNER, Calw (DE)

(21) Appl. No.: 18/704,377

(22) PCT Filed: Oct. 28, 2022
(86) PCT No.: PCT/EP2022/080167

§ 371 Date: Apr. 24, 2024

(30) Foreign Application Priority Data
Oct. 28, 2021 (DE) 20 2021 105 916.8

(51) Int. Cl. F16B 39/282; B64C 1/00; F16B 5/02

(52) U.S. Cl. CPC F16B 39/282; F16B 5/0208; B64C 2001/009

(57) ABSTRACT

A decompression lock (10) having a bolt comprises at least two separately formed bolt elements (12, 36), wherein a first bolt element (12) comprises a bolt head (14) and a second bolt element (36) comprises a connecting means, the bolt elements (12, 36) are connected to one another in a rotationally fixed manner such that they can be detached from one another, and a clamp element (16) is provided, which enables the detachable connection. The clamp element (16) is connected securely and non-detachably to one of the bolt elements (12, 36), in particular to the first bolt element (12) and is detachably connected to the other bolt element (12, 36).

The invention relates to a decompression lock of the type specified in the preamble of claim 1.

The purpose of decompression locks is to relieve any excess pressure that occurs by releasing a sealing plate from a locking position thereof. These locks are used in the aerospace engineering, for example.

EP 2 904 278 B1 discloses a generic locking bolt of the type comprising two bolt elements. The two bolt elements are connected to one another in a rotationally fixed manner by a releasable clamp in such a way that certain pressure conditions will cause the clamp, which has been slid onto the two bolt elements, to detach from at least one bolt element. Furthermore, a locking element is provided in the second bolt element, which is associated with a fastening element, for example a nut. The locking and fastening function is achieved by the locking bolt interacting with the fastening element. The detachable connection of the two bolt elements is achieved by the reliable clamp which has each of its two ends engaging in a groove provided on either bolt element. The clamp can only be slid into place before the locking bolt is being introduced into a receptacle provided for the locking bolt. Furthermore, the locking bolt can only be inserted into the receptacle when the two bolt elements are connected on one side, which is why, during insertion, the wall elements to be locked or secured may exhibit dynamic deviations relative to one another.

EP 2 410 189 B1 discloses a decompression lock which also consists of a locking bolt having two bolt elements which are detachably connected to one another by a spring mounted between the first and second bolt elements. The first bolt element has a cylindrical cavity extending in a radial direction to the longitudinal axis of the bolt, which cavity surrounds the second bolt element in some areas thereof. The spring is clamped in a radial direction inside the first bolt element between the side wall of the cylindrical cavity of the first bolt element and the outer circumferential surface of the second bolt element. However, this design of a decompression lock requires a large cavity for the spring inserted and thus a space-consuming first bolt element.

The disadvantage of the two decompression locks described above is that they each require an additional separate component for connecting the two bolt elements, which increases manufacturing effort and costs. In addition, this component may be lost or cannot be easily gripped during assembly, which increases the assembly effort.

It is the object of the invention to further develop a decompression lock of the type specified in the preamble of claim 1 in such a way that simple assembly thereof is made possible without impairing the function of the decompression lock, whilst avoiding the above mentioned shortcomings.

This object is accomplished by the characterizing features of claim 1 in conjunction with the features of its preamble.

The dependent claims relate to advantageous further embodiments of the invention.

The invention is based on the realization that structurally integrating the clamp into a bolt element is a simple way of reducing both manufacturing effort and assembly effort.

The invention provides for the clamp element for the bolt elements of the bolt to be designed as a part that is firmly connected to one bolt element on one side and detachably connected to the other bolt element on the other side. In particular, the clamp element is securely and non-detachably connected to the first bolt element, and is detachably connected to the second bolt element.

In a preferred embodiment of the invention, the clamp element securely connected to the first bolt element has at least one retaining finger which extends away from the bolt head in an axial direction along the bolt. This results in a space-saving design.

In one embodiment of the invention, the second bolt element has a groove. The retaining finger, which is securely connected to the first bolt element, engages in this groove. This results in a connection between the two bolt elements that can be detached on one side. The connection is made by simply bringing the two bolt elements together by engaging the retaining finger of the clamp element in the groove of the second bolt element.

Preferably, the first bolt element and the clamp element are made of the same material. This avoids adverse effects regarding the load-bearing capacity or flexibility when different materials interact.

In one embodiment of the invention, the first bolt element and the clamp element are formed as a single injection-molded part. The single injection-molded part design ensures uniform material properties for the first bolt element with the clamp element without any joints of different materials that would affect the strength of the part.

Preferably, the first and second bolt elements are made from the same material, preferably stainless steel. For this purpose, the components can be manufactured by metal powder injection molding, for example. This manufacturing process ensures that the manufacturing tolerances can be adhered to very well.

In another embodiment of the invention, the two bolt elements are made of different materials. This allows more cost-effective variants to be produced for applications that are less demanding in terms of material and holding forces.

In order to achieve a larger bearing surface for the bolt head, a washer is arranged between the free end of the first bolt element and the bolt head of the first bolt element.

In particular, the clamp element, and thus the first bolt element, pass through the washer in the axial direction along the longitudinal axis of the bolt.

In order to secure the washer against unintentional loss, but also to restrict the movement of the washer, the clamp element is designed to have at least one retaining means between the bolt head and the retaining finger of the first bolt element. This keeps the washer in the required horizontal alignment during assembly.

In particular, the retaining means is designed as a projection that extends in a radial direction in relation to the longitudinal extent of the retaining finger, preferably on the outside of the retaining finger.

Preferably, inclined guiding surfaces are provided on the projection to enable easy insertion and removal of the washer from the clamp element of the first bolt element.

In one embodiment of the invention, the clamp element is provided with two retaining fingers, which are arranged opposite one another in the bolt element.

Preferably, the first bolt element is formed symmetrically with the clamp element in relation to a plane through the longitudinal axis of the first bolt element. This ensures a uniform retaining function of the clamp element on the second bolt element. The forces that occur are evenly distributed.

In one embodiment of the invention, the decompression lock is designed in such a way that the clamp element engages around parts of an insertion space with its at least two retaining fingers. Furthermore, a bolt shaft is provided concentrically to the bolt head on the side facing the insertion space. A concentric bolt receptacle assigned to the second bolt element is introduced into this bolt shaft. On the side of the second bolt element facing the bolt receptacle, a bolt plunger is arranged that is complementary in shape to the bolt receptacle. The bolt plunger is inserted into the bolt receptacle in a form-fitting manner. A conical insertion area, which merges into a shaft of the second bolt element, adjoins the bolt plunger of the second bolt element. This ensures simple, guided insertion of the bolt plunger into the bolt receptacle for connecting the two bolt elements.

In particular, the groove provided for the clamp element is made in the shaft adjacent to the cone.

In order to achieve a non-rotatable connection between the two bolt elements, the shape of the bolt plunger and that of the bolt receptacle complementary in shape thereto are designed accordingly.

In particular, the bolt plunger and the bolt receptacle complementary in shape thereto can be of a polygonal design.

Additional advantages, features and possible applications of the present invention will be apparent from the description which follows, in which reference is made to the embodiments illustrated in the drawings.

Throughout the description, the claims and the drawings, those terms and associated reference signs are used as are stated in the list of reference signs below. In the drawings,

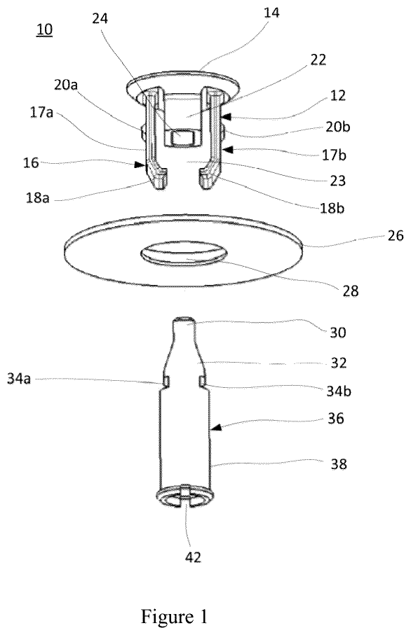

FIG. 1 is an exploded view of the decompression lock comprising a first bolt element, a second bolt element and a washer;

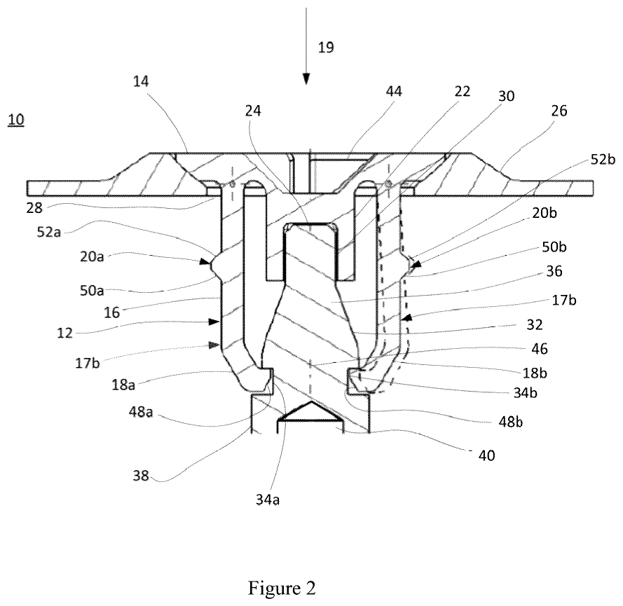

FIG. 2 is a detailed view in longitudinal section of the first bolt element with an inserted second bolt element and a washer, and

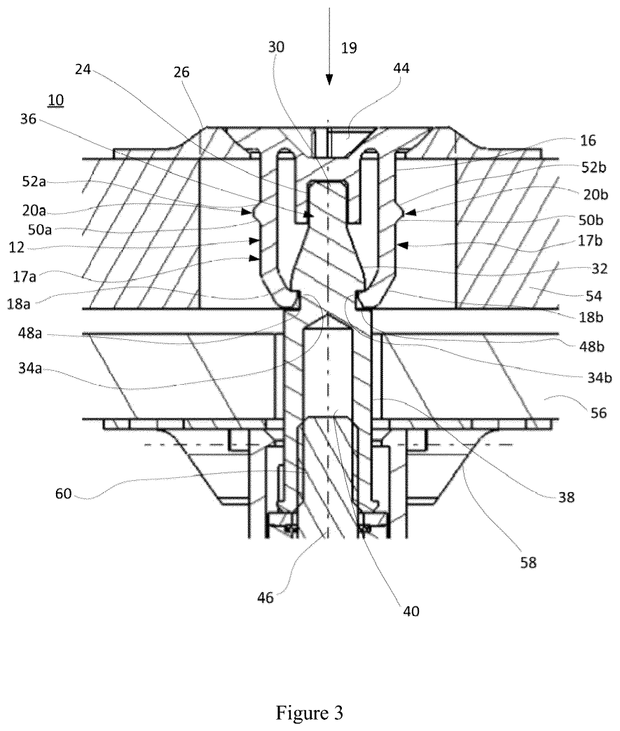

FIG. 3 is a sectional view of the decompression lock with two components and locking means.

FIG. 1 to FIG. 3 each show a decompression lock 10 with a bolt and a washer 28. The bolt comprises two bolt elements 12, 36, with the first bolt element 12 having a clamp element 16.

The clamp element 16 is fixedly connected to the first bolt element 12 on one side, i.e. it is formed in one piece from the same material. A retaining finger 18a, 18b is attached to the free end of the clamp element 16. The clamp element 16 is elastically deformable and acts as a spring element. At the end remote from the free end of the retaining fingers 18a, 18b, the first bolt element 12 has a bolt head 14 with a first engagement structure 42 for a tool for applying a torque. In the axial direction along the direction of insertion 19, a retaining projection 20a, 20b oriented in the radial direction to the direction of insertion 19 is arranged on the outside of the clamp element 16 between the bolt head 14 and the retaining finger 18a, 18b.

In one embodiment, the first bolt element 12 can be formed with the clamp element 16 as a single injection-molded part. The first bolt element 12 and the clamp element 16 are made of the same material.

As is seen in FIGS. 1 to 3, the clamp element 16 has two elastically deformable clamp legs 17a, 17b which are symmetrical to the longitudinal axis 46 of the bolt and have the elastically deformable retaining fingers 18a, 18b and retaining projections 20a, 20b arranged on the outside of the clamp legs 17a, 17b. The retaining projections 20a, 20b have lead-in chamfers 50a, 50b and lead-out chamfers 52a, 52b to facilitate assembly. Furthermore, the retaining fingers 18a, 18b are also provided with lead-in chamfers 48a, 48b.

On the side facing the second bolt element 36, the first bolt element 12 has a concentrically formed first bolt shaft 22 with a bolt receptacle 24 concentrically introduced into the bolt shaft 22. The first bolt shaft 22 is located in the insertion space 23 delimited by the clamp element 16 in the radial direction to the insertion direction 19.

The second bolt element 36 ends with a bolt plunger 30 on the side facing the first bolt element 12. The second bolt element 36 is conically shaped as an insertion cone 32 from the bolt plunger 30 in the axial direction along the insertion direction 19. A cylindrical second bolt shaft 38 adjoins the insertion cone 32 in the axial direction. In the transition area of the insertion cone 32 to the second bolt shaft 38, two retaining grooves 34a, 34b made symmetrically into the second bolt element 36 are provided.

The shape-complementary design of the bolt plunger 30 and the bolt receptacle 24 is polygonal, namely square.

As seen in FIG. 1, a locking receptacle 40 is provided at the free end of the second bolt element 36. According to FIG. 2 and FIG. 3, the locking receptacle 40 is incorporated concentrically into the second bolt element 36 in the axial direction opposite to the direction of insertion 19 and extends in the second bolt element up to just before the axial position of the retaining groove 34a, 34b. The locking receptacle 40 is formed by a thread. An engagement structure 44 for a tool for applying a torque is provided at the free end of the second bolt element 36.

The locking function is realized by introducing a locking element 60, for example a screw, and its interaction with a locking means 58, as shown in FIG. 3.

As seen in FIGS. 2 and 3, the bolt is inserted through a washer opening 28 of a washer 26 in the connected state. The washer 26 serves to increase the bearing surface of the bolt head 14. The bolt head 14 and the washer 26 are adapted to one another so that a flat surface is formed on the outside in the region of the bolt head 14. The connected state of the two bolt elements 12, 36 is characterized by the fact that the bolt plunger 30 is inserted into the bolt receptacle 24 and the retaining fingers 48a, 48b engage in the retaining groove 34a, 34b. In the connected state, the two bolt elements 12, 36 are non-rotatably connected to one another by the design of the bolt plunger 30 and the bolt receptacle 24. The axial movement of the washer 26 relative to the bolt is limited in the direction of insertion 19 by the retaining projections 20a, 20b and counter to the direction of insertion 19 by the bolt head 14. It is easy to insert and remove the washer 26 from the first bolt element 12 due to the lead-in chamfers 50a, 50b and lead-out chamfers 52a, 52b attached to the retaining projections 20a, 20b and the elastic deformability of the clamp element 16. The bolt head 14 can be completely countersunk into the washer 26.

In FIG. 2, the elastic deformability of the clamp element 16 is illustrated by the dashed line on the second clamp leg 17b and second retaining finger 18b. Due to the elastic deformability, the connected state of the two bolt elements 12, 36 can be produced, and released again in the event of certain pressure conditions or during removal by pivoting the clamp legs 17a, 17b and retaining fingers 18a, 18b outwards. The two bolt elements 12, 36 are connected by bringing the two bolt elements 12, 36 together in the axial direction relative to the insertion direction 19. The clamp legs 17a, 17b and the retaining fingers 18a, 18b are deformed by the insertion cone 32 in a radial direction relative to the insertion direction 19 in order to enable insertion of the second bolt element 36 into the insertion space 23. The retaining fingers 18a, 18b then snap into the retaining grooves 34a, 34b as the second bolt element 36 moves further axially in the insertion space 23. At the same time, the bolt plunger 30 is introduced into the bolt receptacle 24 in a form-fitting manner. The insertion of the second bolt element 36 into the insertion space 23 is additionally simplified by the lead-in chamfers 48a, 48b of the retaining fingers 18a, 18b. The engagement structures 42, 44 for a torque of the first and second bolt element 12, 36 act to implement an alignment function of the bolt receptacle 24 relative to the bolt plunger 30 and the retaining groove 34a, 34b relative to the retaining fingers 18a, 18b in the circumferential direction of the bolt.

A force acting in the axial direction along the direction of insertion 19, for example due to certain pressure conditions in an aircraft, causes the connection between the two bolt elements 12, 36 consisting of retaining fingers 18a, 18b and retaining grooves 34a, 34b to be released on one side. At the same time, the bolt plunger 30 is removed from the bolt receptacle 24. The washer 26, into which the first bolt element 12 is inserted, is further secured by the retaining projections 20a, 20b in the axial direction in the direction of insertion 19 between the bolt head 14 and the retaining projections 20a, 20b.

FIG. 3 illustrates an application of the decompression lock 10 for the detachable connection of component 54 and component 56. An unlocked state is shown, which is characterized by an air layer between component 54 and component 56 and a closure element 60 that is not fully inserted into the locking receptacle 40.

### LIST OF REFERENCE SIGNS

10 decompression lock
12 first bolt element
14 bolt head
16 clamp element
17a first clamp leg
17b second clamp leg
18a first retaining finger
18b second retaining finger
19 direction of insertion
20a first retaining projection
20b second retaining projection
22 first bolt shaft
23 insertion space
24 bolt receptacle
26 washer
28 washer opening
30 bolt plunger
32 insertion cone
34a first retaining groove
34b second retaining groove
36 second bolt element
38 second bolt shaft
40 locking receptacle
42 engagement structure for a torque of the second bolt element 36
44 engagement structure for a torque of the first bolt element 12
46 longitudinal axis
48a lead-in chamfer of the first retaining finger 18a
48b lead-in chamfer of the second retaining finger 18b
50a lead-in chamfer of the first retaining projection 20a
50b lead-in chamfer of the second retaining projection 20b
52a lead-out chamfer of the first retaining projection 20a
52b lead-out chamfer of the second retaining projection 20a
54 component
56 component
58 locking means
60 locking element

1-19. (canceled)

20. A decompression lock (10) having a bolt, comprising
at least two separately formed bolt elements (12, 36),
wherein a first bolt element (12) comprises a bolt head (14) and a second bolt element (36) comprises a connecting means, which bolt elements (12, 36) are connected to one another in a rotationally fixed manner such that they can be detached from one another, and a clamp element (16) is provided, which enables the detachable connection, and
wherein the clamp element (16) is connected securely and non-detachably to one of the bolt elements (12, 36), in particular to the first bolt element (12), and is detachably connected to the other bolt element (12, 36).

21. The decompression lock according to claim 20, wherein the clamp element (16) comprises at least one retaining finger (18a, 18b) that extends away from the bolt head (14) along the first bolt element (12).

22. The decompression lock according to claim 20, wherein the free end of the retaining finger (18a, 18b) engages in the second bolt element (36).

23. The decompression lock according to claim 22, wherein the second bolt element (36) comprises a groove (34a, 34b) in which the free end of the retaining finger (18a, 18b) engages.

24. The decompression lock according to claim 20, wherein the clamp element (16) and the first bolt element (12) are formed from the same material.

25. The decompression lock according to claim 24, wherein the clamp element (16) and the first bolt element (12) together form a single injection-molded part, in particular a metal powder injection-molded part.

26. The decompression lock according to claim 20, wherein the first and second bolt elements (12, 36) are made of the same material, in particular stainless steel.

27. The decompression lock according to claim 20, wherein the first and second bolt elements (12, 36) are made of different materials.

28. The decompression lock according to claim 20, wherein a washer (26) is provided for enlarging the bearing surface of the bolt head (14), said washer being arranged between the bolt head (14) and a free end of the bolt.

29. The decompression lock according to claim 28, wherein the clamp element (16) engages through the washer (26) in the axial direction.

30. The decompression lock according to claim 28, wherein the washer (26) mounted on the clamp element (16) is secured in its position between the bolt head (14) and the retaining finger (18a, 18b) by at least one retaining means provided on the clamp element (16).

31. The decompression lock according to claim 30, wherein the retaining means is designed as a projection (20a, 20b) that extends in the radial direction with respect to the longitudinal extent of the retaining finger (18a, 18b), in particular on the outside of the retaining finger (18a, 18b).

32. The decompression lock according to claim 31, wherein the projection (20a, 20b) comprises guide slopes (50a, 50b, 52a, 52b) for the washer (26).

33. The decompression lock according to claim 21, wherein the clamp element (16) comprises two retaining fingers (18a, 18b) which are arranged opposite one another.

34. The decompression lock according to claim 20, wherein the unit constituted by the first bolt element (12) and the clamp element (16) is formed symmetrically along a plane through the longitudinal axis (46) of the bolt.

35. The decompression lock according to claim 33, wherein the clamp element (16) delimits an insertion space (23) with its at least two retaining fingers (18a, 18b), in that the first bolt element (12) comprises, in addition to the bolt head (14), a bolt shaft (22) arranged concentrically with respect to the bolt head (14), in that a concentric bolt receptacle (24) is provided in the bolt shaft (22) on the side of the bolt shaft (22) facing the second bolt element (36), in that the second bolt element (36) comprises, on its side facing the bolt shaft (22), a bolt plunger (30) which is complementary in shape to the bolt receptacle (24), in that the bolt plunger (30) is arranged in the bolt receptacle (24), and in that the bolt plunger (30) is adjoined by a conical insertion region (32) which extends as far as a shaft (38) of the second bolt element (36).

36. The decompression lock according to claim 35, wherein the second bolt element (36) comprises the groove (34a, 34b) in the shaft (38) adjacent to the cone (32).

37. The decompression lock according to claim 35, wherein the shape of the bolt receptacle (24) and the shape of the bolt plunger (30) together act to ensure torsional strength about the longitudinal axis (46) of the bolt elements (12, 36).

38. The decompression lock according to claim 37, wherein the bolt plunger (30) and the bolt receptacle (24) are polygonal in cross-section.
